(19) United States
(12) Patent Application Publication
(10) Pub. No.: US 2015/0081223 A1
(43) Pub. Date: Mar. 19, 2015

(54) MICROSEISMIC SURVEY

(71) Applicant: SCHLUMBERGER TECHNOLOGY CORPORATION, Suger Land, TX (US)

(72) Inventors: Michael John Williams, Cambridge (GB); Joel Herve Le Calvez, Houston, TX (US); Tina Hoffart, Calgary (CA); Geraldine Haas, Katy, TX (US); Daniel Gordon Raymer, Manly (AU); David Pugh, Cambridge (GB)

(21) Appl. No.: 14/490,439

(22) Filed: Sep. 18, 2014

Related U.S. Application Data
(60) Provisional application No. 61/879,966, filed on Sep. 19, 2013.
(60) Provisional application No. 61/927,348, filed on Jan. 14, 2014.

(51) Int. Cl. G01V 1/28; G01V 1/30

(52) U.S. Cl. CPC G01V 1/288; G01V 1/307
USPC 702/14

(57) ABSTRACT

Methods, computing systems, and computer-readable media for processing seismic data. The method may include obtaining a model of a subterranean domain, and determining one or more synthetic waveforms for one or more events located in the subterranean domain, based at least partially on the model. The method may also include identifying, using a processor, one or more arrival waves in the one or more synthetic waveforms, wherein at least one of the one or more arrivals represents a mode-converted wave, and generating a processing chain for determining at least a location of an event in the subterranean domain based at least partially on the at least one mode-converted wave.

### CROSS-REFERENCE TO RELATED APPLICATION

This application claims priority to U.S. Provisional Patent Application having Ser. No. 61/879,966, filed on Sep. 19, 2013, and U.S. Provisional Patent Application having Ser. No. 61/927,348, filed on Jan. 14, 2014. The entirety of each of these applications is incorporated herein by reference.

### BACKGROUND

Microseismic monitoring is used for monitoring hydraulic fracture stimulation treatments in unconventional fields. The hydraulic fracture stimulation treatments cause fractures to propagate in the formation, in turn generating “microseismic” waves that also propagate in the formation. Receiver arrays (e.g., geophones) are positioned, generally in a monitoring borehole or along the Earth's surface, so as to detect and record the arrival of the microseismic waves.

Based on a model of the relevant subterranean volume, the characteristics of the waveform recorded by the receivers may be used, in a process known as inversion, to determine information about the source of the seismic waves (e.g., fracture propagation). Such information may include the general location of the event, moment tensors, and other information. Generally, the inversion process includes considering direct-arrival compression waves and shear waves (both Sh and Sv arrivals).

However, other waves are present in the data and impact accuracy of determinations of event locations and associated attributes. These are sometimes referred to as “mode-converted” wave arrivals. Generally, these types of waves are considered undesirable, and steps may be taken to mitigate the detected energy associated therewith, so as to isolate the direct wave arrivals. In some cases, however, these wave arrivals may be incorrectly picked as a direct-arrival waves, or may otherwise make detection of direct wave arrivals more difficult, thereby potentially increasing uncertainty in the inversion process.

### SUMMARY

Embodiments of the disclosure may provide a method for processing seismic data. The method may include obtaining a model of a subterranean domain, and determining one or more synthetic waveforms for one or more events located in the subterranean domain, based at least partially on the model. The method may also include identifying, using a processor, one or more arrival waves in the one or more synthetic waveforms. At least one of the one or more arrivals represents a mode-converted wave. The method also includes generating a processing chain for determining at least a location of an event in the subterranean domain based at least partially on the at least one mode-converted wave.

In an embodiment, the method further includes constructing a classification data structure that associates respective layers of the subterranean domain with one or more respective characteristics of a waveform caused by an event in the respective layers. The one or more characteristics include a presence of the at least one mode-converted wave in the waveform.

In an embodiment, the method further includes receiving data representing a seismic waveform caused by an event in the subterranean domain, and identifying at least one mode-converted wave arrival in the seismic waveform. The method also includes determining a particular layer of the subterranean domain in which the event occurred, based at least partially on the classification data structure and the at least one mode-converted wave arrival.

In an embodiment, identifying the one or more wave arrivals includes selecting a filter, and applying the filter to the one or more synthetic waveforms. In an embodiment, identifying also includes identifying peaks in the one or more synthetic waveforms after applying the filter. At least one of the peaks represents a direct-arrival wave, and at least another one of the peaks represents the mode-converted wave, and applying the filter to one or more observed seismic waveforms in a processing chain to detect similar events.

In an embodiment, identifying the one or more wave arrivals includes selecting a detection transform, and applying the detection transform to the one or more synthetic waveforms. Identifying the one or more wave arrivals may also include analyzing one more peaks of the detection transform, such that one or more wave arrivals are identified in the synthetic waveform, and determining a catalogue of transforms for calculating an objective function configured to identify wave arrivals in a seismic waveform.

In an embodiment, the method may also include receiving seismic data representing a seismic waveform caused by a test seismic event at a test location, and inverting the seismic data based at least partially on the processing chain, such that a calculated location of the test seismic event in the subterranean domain is determined. The method may also include comparing the calculated location with the test location, and revising the model when the calculated location is outside of a predetermined uncertainty range of the test location.

In an embodiment, the method may include receiving seismic data representing a seismic waveform caused by a microseismic event, and determining a location of the microseismic event based at least partially on the processing chain.

Embodiments of the disclosure may also provide a non-transitory, computer-readable medium storing instructions that, when executed by one or more processors of a computing system, cause the computing system to perform operations. The operations may include obtaining a model of a subterranean domain, and determining one or more synthetic waveforms for one or more events located in the subterranean domain, based at least partially on the model. The operations may also include identifying one or more arrival waves in the one or more synthetic waveforms. At least one of the one or more wave arrivals represents a mode-converted wave. The operations also include generating a processing chain for determining at least a location of an event in the subterranean domain based at least partially on the at least one mode-converted wave.

Embodiments of the disclosure may further provide a computing system. The computing system may include one or more processors and a memory system including one or more non-transitory, computer-readable media storing instruction that, when executed by at least one of the one or more processors, cause the computing system to perform operations. The operations may include obtaining a model of a subterranean domain, and determining one or more synthetic waveforms for one or more events located in the subterranean domain, based at least partially on the model. The operations may also include identifying one or more arrival waves in the one or more synthetic waveforms. At least one of the one or more wave arrivals represents a mode-converted wave. The operations also include generating a processing chain for determining at least a location of an event in the subterranean domain based at least partially on the at least one mode-converted wave.

Embodiments of the disclosure may further provide a computing system. The computing system may include means for obtaining a model of a subterranean domain, and means for determining one or more synthetic waveforms for one or more events located in the subterranean domain, based at least partially on the model. The system may also include means for identifying one or more arrival waves in the one or more synthetic waveforms. At least one of the one or more wave arrivals represents a mode-converted wave. The system may also include means for generating a processing chain for determining at least a location of an event in the subterranean domain based at least partially on the at least one mode-converted wave.

Embodiments of the disclosure may also provide a computer-readable storage medium having a set of one or more programs including instructions that, when executed by a computing system, cause the computing system to obtain a model of a subterranean domain, and determine one or more synthetic waveforms for one or more events located in the subterranean domain, based at least partially on the model. The instructions may also cause the computing system to identify one or more arrival waves in the one or more synthetic waveforms. At least one of the one or more wave arrivals represents a mode-converted wave. The instructions may further cause the computing system to generate a processing chain for determining at least a location of an event in the subterranean domain based at least partially on the at least one mode-converted wave.

Thus, the computing systems and methods disclosed herein are more effective methods for processing collected data that may, for example, correspond to a subsurface region. These computing systems and methods increase data processing effectiveness, efficiency, and accuracy. Such methods and computing systems may complement or replace conventional methods for processing collected data. This summary is provided to introduce a selection of concepts that are further described below in the detailed description. This summary is not intended to identify key or essential features of the claimed subject matter, nor is it intended to be used as an aid in limiting the scope of the claimed subject matter.

### BRIEF DESCRIPTION OF THE DRAWINGS

The accompanying drawings, which are incorporated in and constitute a part of this specification, illustrate embodiments of the present teachings and together with the description, serve to explain the principles of the present teachings.

FIG. 1 illustrates a flowchart of a method for processing seismic data, according to an embodiment.

FIG. 2 illustrates a flowchart of another method for processing seismic data, e.g., microseismic data, according to an embodiment.

FIG. 3 illustrates a flowchart of a method for identifying wave arrivals in synthetic waveforms, which may be employed as part of the method of FIGS. 1 and/or 2, according to an embodiment.

FIG. 4 illustrates a flowchart of another method for identifying wave arrivals in synthetic waveforms, which may be employed as part of the method of FIGS. 1 and/or 2, according to an embodiment.

FIG. 5-1 illustrates an example full waveform synthetic arrival at a long borehole array, according to an embodiment.

FIG. 5-2 illustrates an empirical transform function which is analyzed to provide additional arrival-based information for the objective function calculation in the CMM algorithm, according to an embodiment.

FIG. 6 illustrates a flowchart of a method for determining a layer location of a microseismic event, according to an embodiment.

FIG. 7-1 illustrates a sub-stack from a surface line of the observing geometry aligned on the P arrival, according to an embodiment.

FIG. 7-2 illustrates several shallow receivers from the long borehole array, according to an embodiment.

FIG. 8-1 illustrates a waveform response of deeper receivers in the long borehole array showing the complexity of the wave arrivals for the event, according to an embodiment.

FIG. 8-2 illustrates a waveform response of the deeper receivers in the long borehole array showing similarly complex wave arrivals for the event, according to an embodiment.

FIG. 9-1 illustrates a lower frequency extended arrival with relatively little S-energy observed on a cross-line of the observed geometry, according to an embodiment.

FIG. 9-2 illustrates surface data and the receivers in the long borehole array, for comparison with FIG. 9-1, which shows the low-frequency P-wave, according to an embodiment.

FIGS. 10-1, 10-2, 10-3, and 10-4 illustrate a flowchart of a method for processing seismic data, according to one or more embodiments.

FIG. 11 illustrates a schematic view of a processor system, according to an embodiment.

### DETAILED DESCRIPTION

Reference will now be made in detail to embodiments, examples of which are illustrated in the accompanying drawings and figures. In the following detailed description, numerous specific details are set forth in order to provide a thorough understanding of the invention. However, it will be apparent to one of ordinary skill in the art that the invention may be practiced without these specific details. In other instances, well-known methods, procedures, components, circuits and networks have not been described in detail so as not to unnecessarily obscure aspects of the embodiments.

It will also be understood that, although the terms first, second, etc. may be used herein to describe various elements, these elements should not be limited by these terms. These terms are only used to distinguish one element from another. For example, a first object or step could be termed a second object or step, and, similarly, a second object or step could be termed a first object or step, without departing from the scope of the invention. The first object or step, and the second object or step, are both, objects or steps, respectively, but they are not to be considered the same object or step.

The terminology used in the description of the invention herein is for the purpose of describing particular embodiments only and is not intended to be limiting of the invention. As used in the description of the invention and the appended claims, the singular forms “a,” “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Further, as used herein, the term “if” may be construed to mean “when” or “upon” or “in response to determining” or “in response to detecting,” depending on the context.

Attention is now directed to processing procedures, methods, techniques and workflows that are in accordance with some embodiments. Some operations in the processing procedures, methods, techniques and workflows disclosed herein may be combined and/or the order of some operations may be changed.

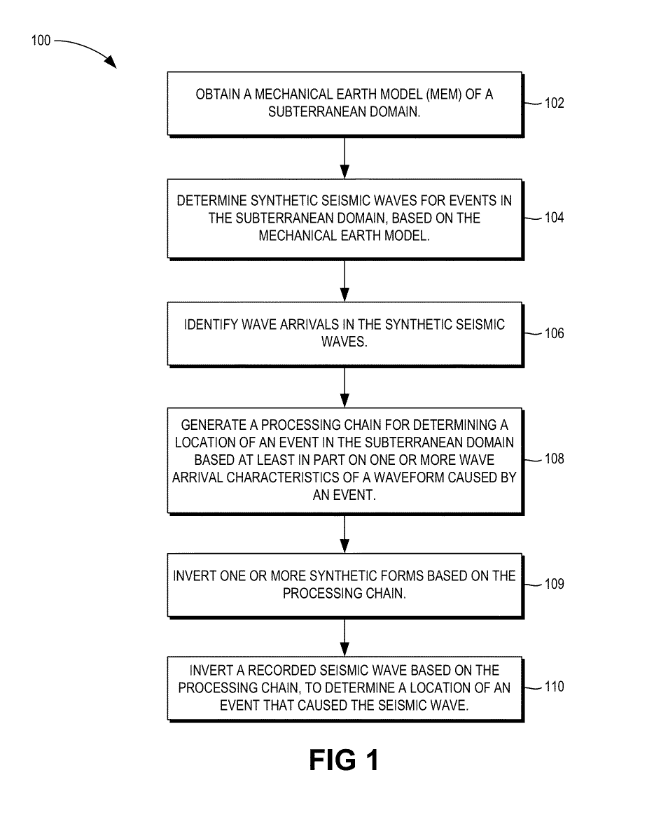

FIG. 1 illustrates a flowchart of a method 100 for processing seismic data, according to an embodiment. In some embodiments, the seismic data may represent seismic waveforms recorded by geophones or other receivers. In some embodiments, the seismic waves may be caused by microseismic events, e.g., as caused by hydraulic fracturing stimulation treatments. Such hydraulic fracturing stimulation treatments may be employed to assist in the recovery of hydrocarbons from unconventional wells. In other embodiments, the method 100 may be employed with other types of seismic data; accordingly, it will be appreciated that microseismic data is but one example of an application of some embodiments of the present method 100, and others are contemplated.

Turning to the illustrated embodiment, the method 100 may include obtaining a mechanical earth model (MEM) of a subterranean domain, as at 102. The method 100 may include defining an initial estimate of the target formation and, in an embodiment, sufficient overburden to accommodate a proposed survey configuration. In some embodiments, the MEM may be constructed as part of obtaining at 102, but in other embodiments, may be received from an external source (e.g., as a pre-existing model). In either example, the MEM may be constructed from a priori known data, such as well (e.g., sonic) logs from nearby wellbores, layer horizon data, fault mapping, and/or velocity models, such as three-dimensional velocity models. One or more of these data sources may be employed to generate an estimate of the geology of the subterranean volume within a volume of interest.

The method 100 may also include determining one or more modeled or “synthetic” seismic waveforms for events in the subterranean domain, as at 104. As also indicated at 104, the synthetic waves may be calculated based on the MEM. For example, an anisotropic finite difference simulation may be employed with the MEM, followed by a ray-tracing method, so as to model one or more (e.g., many) waveforms as they are expected to be received, given a particular event location in the subterranean domain. Accordingly, depending, for example, on the accuracy of the MEM, the waveforms may provide an accurate estimation of the location of an observed seismic event, based on the seismic waveforms matching, or at least being similar to, the one or more synthetic waveforms. In some embodiments, such modeling techniques may be referred to as “forward modeling.”

It will be appreciated that, in this context, “ray tracing” refers to any one of a variety of methods that may be employed to calculate the path of the seismic waves through the rock formations. Accordingly, the forward modeling may result in a set of full-waveform synthetics; however, in some embodiments, partial-waveform synthetics may be modeled additionally or instead.

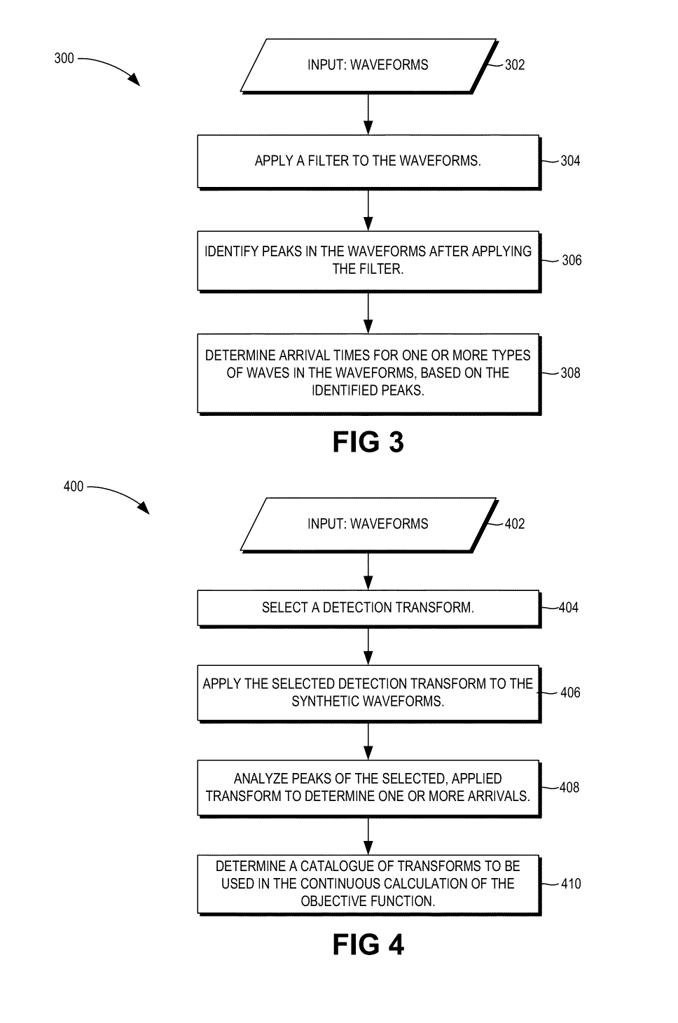

Once at least one of the synthetic waveforms is modeled, the method 100 may include identifying wave arrivals in the synthetic waveform(s), as at 106. Identifying wave arrivals at 106 may include defining filters, Coalescence Microseismic Mapping (CMM) look-up tables, and/or other techniques to identify the wave arrivals on observed waveforms. Additional details regarding examples of implementations of such arrival identification processes are described below with reference to FIGS. 3 and 4.

In general, however, the direct P, Sv, and Sh wave arrivals may be identified, using any suitable process. Further, arrival identification methods such as CMM, cross-correlation filtering, and/or matched filtering may be tuned to pick converted wave arrivals in addition to the direct wave arrivals. The arrivals of converted waves, interface waves, and the like may be related to the impedance contrasts within a three-dimensional representation. Such relation may include summary indices such as the total energy of the arrival, which may be an indicator of waveguides, as will also be described in greater detail below.

Additionally, parallelization of operations may be employed to speed the process of referencing to look-up tables and implementation of event-picking algorithms, since the identification of the different wave arrivals may be at least substantially independent.

The method 100 may also include generating a processing chain for determining a location of an event in the subterranean domain, based at least in part on one or more arrival characteristics of one or more waveforms caused by an event, as at 108. A “processing chain” may be a set of steps, e.g., a workflow, prescribed for determining certain characteristics of the event based on the recorded seismic data. For example, the processing chain may begin with seismic data and may include using an MEM, and potentially other tools, in order to invert the seismic data and determine characteristics about the event that caused the recorded waveforms. These calculated characteristics may then be used to inform stimulation and/or drilling processes, and may be employed to update the MEM itself.

In some embodiments, the processing chain may be a “real-time” processing chain. That is, the processing chain may be configured to determine the prescribed characteristics without significant delay, e.g., to support field operations on-the-fly. For example, during a hydraulic fracturing stimulation operation, an array of receivers may monitor the formation for seismic waves. In a specific example, the receivers may acquire data at a rate of every ¼ ms for 8 hours. This may represent a large amount of data, which a mobile unit containing a computer may be configured to analyze. To conduct the analysis, the computer may consider at least some of the seismic data and determine one or more characteristics of the event, e.g., to provide information about crack propagation to those conducting the hydraulic fracturing operation. In response, the operations conducting the hydraulic fracturing operation may adjust one or more treatment parameters, if the event data indicates the fracture propagation is deviated from an intended design.

The method 100 may then proceed to inverting the synthetic waveforms, e.g., full-waveform synthetics, e.g., to obtain event locations, as at 109. In some embodiments, the waveform inversion processing may not be full-waveform, and thus the use of a full-waveform synthetics inversion test may assist in determining an accuracy of the real-time processing chain, and/or any other elements of the method 100. In some cases, the method 100 may also include obtaining the moment tensors by the inversion at 109.

One goal of this testing process may be to determine one or more monitoring options, e.g., observing systems, which may include where to locate the receivers. To do so, several such options may be considered as part of the method 100. The observing systems may include one or more borehole arrays, deviated wells, fiber-optic-based systems, broadband stations, surface lines and patches, and shallow wells in any combination. In some systems, the use of different wave modes may aid the locations of events at different distances, or aid the placement of events in different layers.

In an embodiment, the combinatorial nature of advocating several additional arrival wave types together with several monitoring options may result in a probabilistic experimental design technique for use in determining suitable array options that may then used to aid the decision of which survey geometry meets cost and experimental constraints. The available designs may be used (e.g., manually) with the synthetics modeled at 104 as input and the error in recovering event locations using the real-time processing chain as a guide to the potential performance during the observation workflow phase, as described below.

With the MEM created and the (e.g., real-time) processing chain created, the method 100 may be employed with test and/or observed, physical microseismic events. Accordingly, the method 100 may include inverting a recorded seismic wave based on the processing chain, to determine a location of an event that caused the seismic wave, as at 110. In some embodiments, the seismic event may be a physical test, such as a stringshot in the well or a perforation shot, or may be a hydraulic fracturing event. The method 100 at block 110 may thus include determining one or more characteristics, such as location and/or moment tensor, based on the arrivals contained in the seismic waveform.

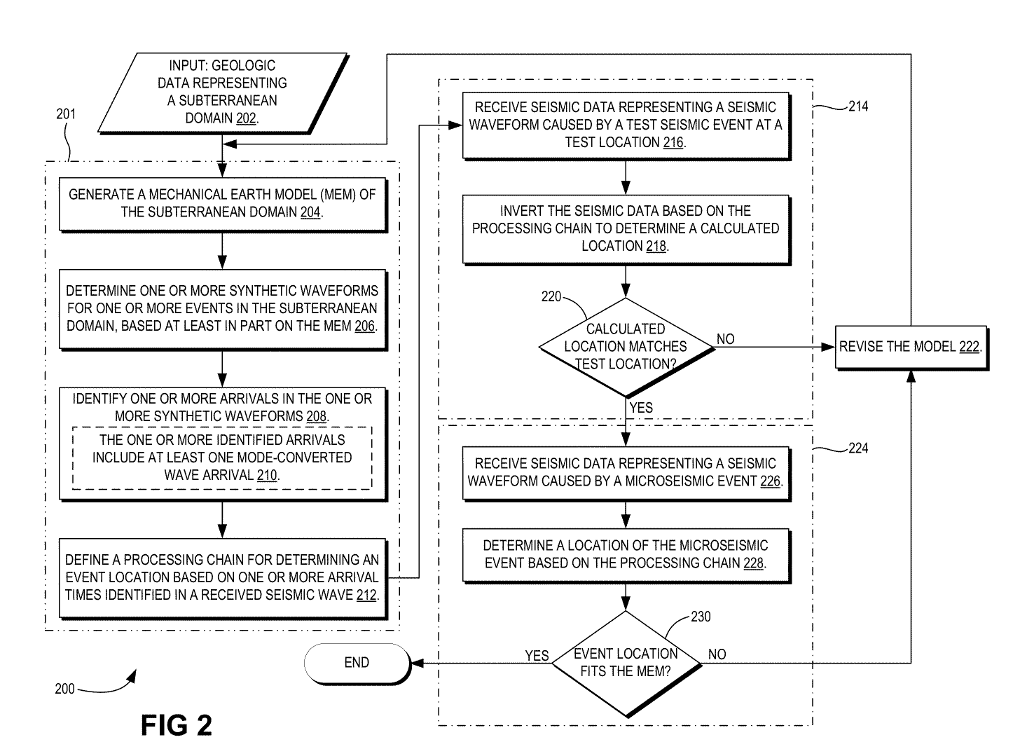

FIG. 2 illustrates a flowchart of another method 200 for processing seismic data, according to an embodiment. The method 200 depicted may be a more-detailed depiction of at least some embodiments of the method 100, and thus the two should not be considered to be mutually exclusive.

In the illustrated embodiment, the method 200 may receive, as input, geologic data representing a subterranean domain, as at 202. As mentioned above, this input may include any available data representing the subterranean domain (e.g., volume or cube) of interest, including velocity models, layering data, fault mapping, etc.

The method 200 may then, in some embodiments, enter a “job design workflow” phase, as indicated at 201. This phase 201 may include, based on this input, generating a mechanical earth model (MEM) of the subterranean domain, as at 204. Using isotropic and/or anisotropic finite element analysis and ray tracing, for example, the method 200 may include determining one or more synthetic waveforms for one or more events in the subterranean domain, as at 206. The waveforms may be determined at least partially based on the MEM. For example, using the elastic finite difference techniques, multiple waveforms at different receiver locations may be modeled for events occurring at one or several “target” locations in the subterranean domain and compared to arrival time information provided by ray-tracing techniques. Accordingly, expected waveforms for such events may be determined, for later comparison to test and/or actual events, in order to determine characteristics of these events.

The method 200 may also include identifying one or more wave arrivals in the one or more synthetic waveforms, as at 208. In at least one embodiment, the one or more identified wave arrivals may include at least one mode-converted wave arrival, as at 210. In particular, for example, the arrival of the mode-converted waves with respect to the arrival times of the direct-arrival waves may be noted, which may assist with precise location of events during inversion, as will be described in greater detail below.

The method 200 may also include defining a processing chain for determining an event location based on one or more arrival times identified in a received seismic wave, as at 212. The processing chain may be a real-time processing chain. Further, the processing chain may provide a series of actions, e.g., independent actions, that may be taken manually and/or automatically, in order to determine characteristics of an event based on one or more recorded waveforms and the MEM.

In general, in a microseismic context, a processing chain may include a preliminary filtering step, and a single-trace, automated detection of potential events. The processing chain may also include a multi-trace detection of potential events (e.g. CMM), and an inversion for event location. The processing chain may also include a refinement of that event location, and a determination of event source parameters and moment tensor.

The method 200 may then proceed to an “observation workflow” phase, as indicated at 214. The observation workflow phase 214 may include receiving seismic data representing a seismic waveform caused by a test seismic event at a test location, as at 216. The test seismic event may be a physical event, such as a stringshot in the well, a perforation shot, etc., or may be a modeled event, with the seismic data being, for example, a full-waveform synthetic. In some embodiments, the seismic data processing chain 108 and inversion 109 may not be full-waveform, and thus a full-waveform, synthetic test may provide additional insight into the performance of the inversion 110, the accuracy of the MEM, the arrival identification process, and the like.

The seismic data received at 216 may then be inverted, as at 218, e.g., based on the processing chain to determine a calculated location of the event. The calculated location may be compared to the a priori known location of the test event, as at 220, to determine an accuracy of the MEM and the processing chain. If the calculated location does not “match” the test location (e.g., the calculated location is not within an uncertainty tolerance of the test event location), the method 100 may proceed to revising the model, as at 222.

If the determination at 220, which may occur potentially many times, is positive, the method 100 may proceed to an “interpretation workflow” phase 224, in which the processing chain may be employed to analyze recorded data. The interpretation workflow phase may thus include receiving seismic data representing a seismic waveform caused, e.g., by a microseismic event, as at 226. A location of the microseismic event, and potentially other characteristics, such as moment tensor, associated with the event, may then be determined as at 228, e.g., using the processing chain.

The method 200 may also consider whether the event location fits the model, as at 230. For example, if the event location is calculated to be in a position where it is impossible or unlikely to have occurred, the calculated event location may be determined to not fit the model (determination at 230 is ‘NO’), and the method 200 may proceed to revising the model (and/or any element of the processing chain), as at 222. Otherwise, the method 200 may continue collecting and analyzing data, until such time as no further analysis is needed (permanently or temporarily), at which point the method 200 may end. In at least one embodiment, the method 200, prior to ending, may display a location of the event, whether physical or modeled, in the mechanical earth model and/or may display an updated or “transformed” version of the MEM after it has been revised at 222.

FIG. 3 illustrates a flowchart of a process 300 for identifying wave arrivals in a waveform, according to an embodiment. The process 300 may be employed to, for example, identify waveforms in wave arrivals in the synthetic waveforms, as at 208 (FIG. 2), e.g., during the job-design workflow phase 201. Further, the process 300 may be employed as part of the processing chain, e.g., to identify wave arrivals in a test or stimulation-related, microseismic event, in order to determine a location thereof, as at 218 and/or 228 (FIG. 2), e.g., as part of the observation and/or interpretation workflow phases 214, 224. During the job-design workflow 201, the process 300 may operate to design a suitable filter, which removes noise and/or target other energy for removal from the waveform, while preserving useful arrival data. Once designed, the filter may be employed, e.g., in the observation and/or interpretation workflow phases 214, 224, in order to remove the noise and/or other types of energy.

Accordingly, the process 300 may include receiving waveforms as input, as at 302. The waveforms may be full-waveform synthetics or recorded waveforms, e.g., depending on the workflow phase. The process 300 may then apply a filter to the waveform, as at 304.

The process 300 may then include analyzing the energy/amplitude peaks in the waveforms after applying the filter, as at 306. The process 300 may use the results of this analysis to determine arrival time and wave-types, based on the identified peaks, as at 308. The arrival times may be determined, for example, using a ray-tracing technique.

In some embodiments, determining arrival time and wave-types based on the identified peaks at 308 may include identifying direct P, Sv, and Sh wave arrivals. Further, arrivals of converted waves, interface waves, etc. may be related to impedance contrasts within the three-dimensional representation, e.g., using CMM, cross-correlation filtering, and/or matched filtering, as noted above.

FIG. 4 illustrates another method 400 for identifying wave arrivals in a waveform, according to an embodiment. The method 400 may be used in the job-design workflow phase 201, the observation workflow phase 214, and/or the interpretation workflow phase 224. In an embodiment, this aspect of the method 400 may proceed according to a modified CMM approach.

In the CMM approach, a set of transforms, for example, the ratio of the short-term average to the long term average (STA/LTA), of the input waveform may be beam-formed (e.g., continuously) to construct an objective function for a trial set of source locations. As such, the CMM approach may be considered a model-driven approach. In an embodiment, the method 400 may employ such a model-driven approach while using full-waveform synthetics to refine the transforms applied to the waveform.

Specifically, in an embodiment, a detection transform may be selected for application to a full-waveform synthetic, as at 404. Once selected, the detection transform may then be applied to the full-waveform synthetic, as at 406.

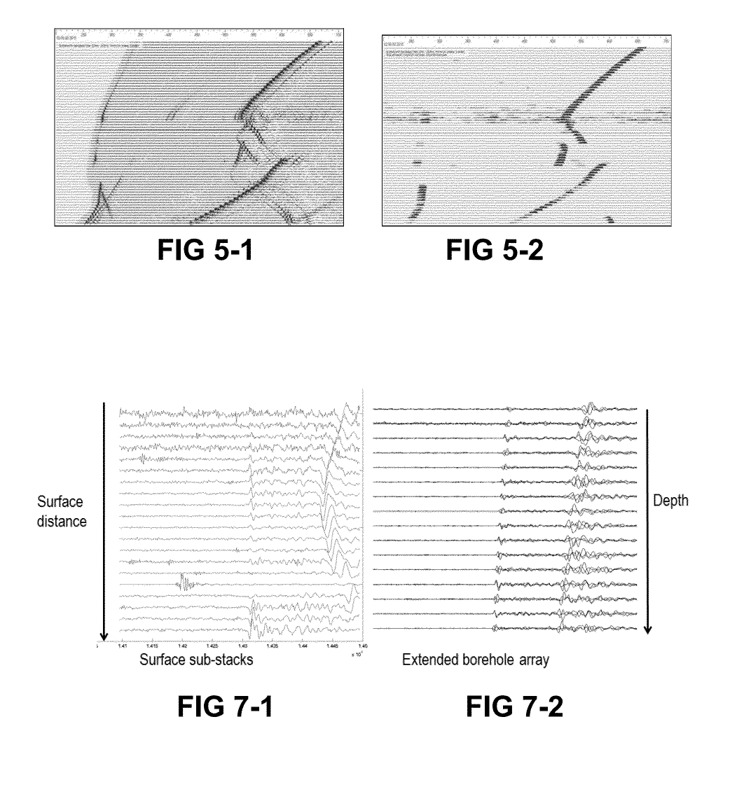

FIG. 5-1 illustrates an example of a full waveform synthetic, which has a detection transform applied thereto, as shown in FIG. 5-2. Referring back to FIG. 4, the transform may then be then analyzed for peaks, as at 408. The peaks may be used to determine a catalogue of transforms to be used in the continuous calculation of the objective function, as at 410. The example in FIG. 5-2 shows that, in this way, event detection responses may be recovered over parts of the waveform dominated by complex wave arrivals.

In some embodiments, full waveform synthetics may be created for a number of event locations. Referring again to FIG. 5-1, there is shown an example of the arrival on the full length of a long-borehole array. These synthetics, which capture many of the features of the observed complex waveforms, may then be used to empirically construct additional transform templates for use in the CMM objective function.

An extension to the CMM approach, e.g., according to an embodiment of the method 400, may allow for extracting the appropriate arrival times via STA/LTA (or another transform) processing of the full waveform synthetics. These times are then used to augment the first arrival P and S travel times in the objective function used for CMM processing, allowing the energy in complex wave arrivals to be identified and beam-formed in the event detection algorithm. Mode-converted wave arrivals may also be used in any subsequent Geiger relocations to provide greater aperture with which to refine the event location.

Individual waveforms of microseismic events may be identified and tracked from reservoir to surface using a wide aperture borehole seismic array, and then across surface seismic lines. Deeper wave arrivals in the long borehole array may contain complex triplications that may, in some embodiments, pose a difficulty for event detection and location techniques based on identifying the direct wave arrivals, which may be mitigated by the detection of the more complex waves.

According to an embodiment, full-waveform synthetics model the principal features of these complex wave arrivals at the long borehole array, reproducing the major features of the waveform. An extension to the CMM approach is provided to allow extraction of appropriate model-driven transforms, which are peaked at the arrival times, e.g., at 406 via STA/LTA processing of the full waveform synthetics. These transforms are then used to augment the first arrival P and S travel times in the objective function used for CMM processing, allowing the energy in complex wave arrivals to be identified and beam-formed in the event detection algorithm. Mode-converted wave arrivals may also be used in a subsequent Geiger relocation to provide greater aperture with which to refine the event location.

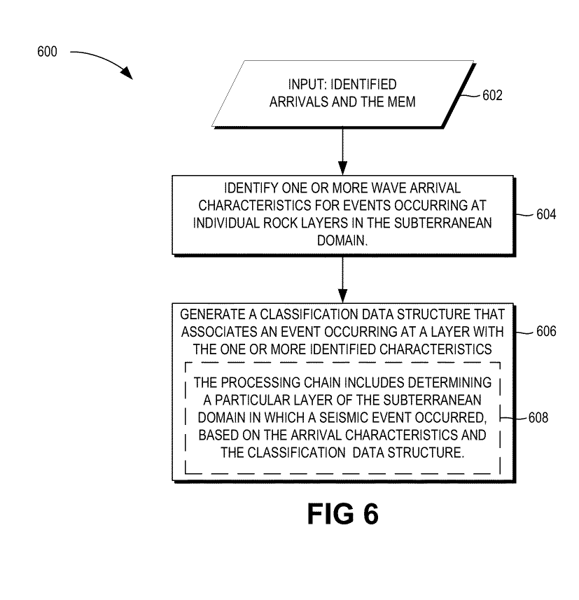

FIG. 6 illustrates a flowchart of a method 600 for determining a layer location of a microseismic event, according to an embodiment. In general, the method 600 may include defining a look-up table, which may make use of mode-converted and/or other wave types, as well as direct-arrivals, and knowledge of the geology of the subterranean volume, in order to more precisely pinpoint a layer in which an event has occurred.

The method 600 may, in an embodiment, receive identified wave arrivals and the mechanical earth model (MEM) as an input, as at 602. These may have been previously determined as part of the method 200, of which the method 600 may be a part. Using the identified wave arrivals, the method 600 may include identifying one or more arrival characteristics for events occurring at individual rock layers in the subterranean domain, as at 604.

Further, the method 600 may include generating a classification data structure (e.g., table) that associates an event occurring at a layer with one or more identified characteristics or “triggers,” as at 606. For example, the process may establish a look-up table with two, three, five, ten or more triggers, related to the characteristics of the waveforms (e.g., the arrival times of the various waves), including the arrival times of mode-converted waves, and/or even the presence thereof. In an embodiment, the classification may take the form of a probability table where an automated software estimates the likelihood of an event originating in a particular layer.

The processing chain, e.g., as constructed as part of the method 200 at 212, may include determining a particular layer of the subterranean domain in which the seismic event occurred, based on the arrival characteristics and the classification data structure, as indicated at 608. This classification data structure may capitalize on the non-direct arrival waves (e.g., mode-converted waves) that certain geologies may be known or otherwise observed to create. For example, the mode-converted waves, interface waves, etc., may be related to the impedance contrasts within a three-dimensional representation. This may include summary indices such as the total energy of the arrival, which may be an indicator of waveguides.

Waveguides may be an instance where two relatively “slow” layers (e.g., of shale) are disposed above and below a faster-propagating layer or two relatively “fast” layers (e.g. of limestone) above and below a slower-propagating layer. Accordingly, information about the location of these waveguides, and the waveforms produced by events occurring in the wave guides, may provide additional detailed location information, e.g., down to a specific layer of rock, in which an event occurred. This may decrease a window of uncertainty which may be seen in seismic inversion, whether based on a full or partial waveform, while reducing computing time.

Thus, a matching of characteristics may be conducted, e.g., automatically, to determine if a waveform, or stack of waveforms, indicates than an event occurred at a particular layer, based on the information stored in the classification structure (look-up table).

### EXAMPLE

An understanding of the embodiments of the present disclosure may be furthered with reference to the following non-limiting example.

A system of receivers may simultaneously track signals and noise from a reservoir to the surface and then across the surface. This may illustrate a comparison between surface sub-stacks and long-borehole array single-sensor data to demonstrate that the same events are observed by the two monitoring configurations.

The surface and long-borehole array data may be analyzed using a first-arrival based Coalescence Microseismic Mapping (CMM) approach, employing beam-forming via model-driven transforms. The surface array data was stacked into 25-trace sub-stacks, and then events were identified in the stacked traces; for the long-borehole array the waveforms were not stacked.

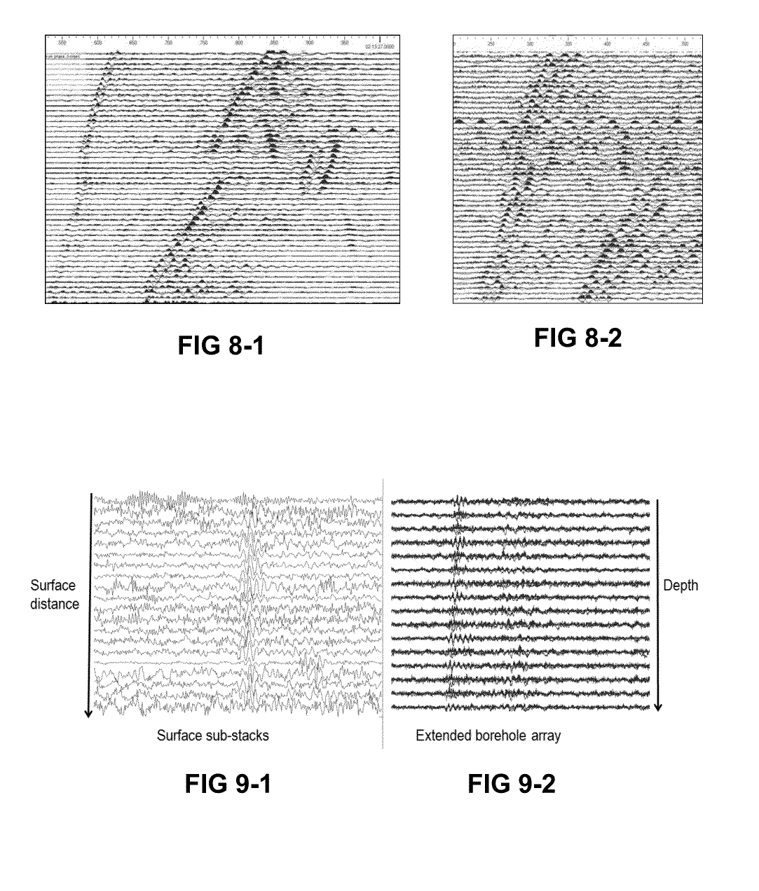

For a single stage, 98 events were identified in the surface stacks. For each event the surface sub-stacks were plotted aligned with compressional body wave expressions, and the arrival from this event on the long borehole array was identified and plotted for comparison. FIGS. 7-1 and 7-2 show an example where both the compressional (P) and shear (S) wave arrivals were readily identified in the surface sub-stack (FIG. 7-1). It is evident using arrival times and waveforms that the same event has also been detected by the upper receivers of the long borehole (FIG. 7-2). Deeper in the long borehole array (FIG. 8-1), the wavefront shows triplication, particularly in the S-arrival, which may make the use of the long borehole array with a standard first-arrival detection approach much more challenging than if the waveform geometry had not displayed triplication.

A second type of event is shown in FIGS. 9-1 and 9-2. Here the surface data (FIG. 7-1) shows a relatively extended low frequency event consisting of mostly P energy. Observations on the shallow receivers from the long array (FIG. 9-2) indicate that indeed the S-arrival is fairly weak at shallow depths and with the arrival time at the surface array again supporting the observation that the same event is observed via both approaches. In the deeper receivers of the long borehole array (FIG. 8-2), we see that the arrival contains relatively low frequencies and is again complex on the deeper part of the array and that the S-wave is attenuated in the formation. A catalogue of examples may be calculated in which the downhole and surface responses were correlated, and within this catalogue examples may be identified where the observations on the lower part of the long borehole array contained significant energy on arrivals other than direct P and S wave arrivals. The method presented below may take advantage of this waveform energy within the existing CMM approach.

FIGS. 10-1, 10-2, 10-3, and 10-4 illustrate a flowchart of a method 1000 for processing seismic data, according to one or more embodiments. The method 1000 may include obtaining a model of a subterranean domain, as at 1002 (e.g., FIG. 1, 102, obtaining a mechanical earth model of a subterranean domain). The method 1000 may also include determining one or more synthetic waveforms for one or more events located in the subterranean domain, based at least partially on the model, as at 1004 (e.g., FIG. 1, 104, determining synthetic seismic waves for events in the subterranean domain, based on the MEM).

The method 1000 may also include identifying, e.g., by operation of or otherwise using a processor, one or more arrival waves in the one or more synthetic waveforms, as at 1006 (e.g., FIG. 1, 106, identifying arrival waves in the synthetic seismic waves). In an embodiment, at least one of the one or more wave arrivals represents a mode-converted wave, as at 1008 (e.g., FIG. 2, 210, the one or more identified wave arrivals include at least one mode-converted wave arrival). In an embodiment, identifying at 1006 may include selecting a filter, as at 1008 (e.g., FIG. 3, 304, a filter, to be applied, is selected). The filter may be applied to the one or more synthetic waveforms, as at 1010 (e.g., FIG. 3, 304, apply the selected filter). Further, in an embodiment, peaks in the one or more synthetic waveforms may be identified, after applying the filter, as at 1012 (e.g., FIG. 3, 306, identify peaks in the waveforms after applying the filter). Further, at least one of the peaks may represent a direct-arrival, and at least another one of the peaks may represent the mode-converted wave, as at 1014 (e.g., FIG. 3, 308, the identified peaks may represent energy associated with direct-arrivals and mode-converted waves). In an embodiment, the filter may be applied to one or more observed seismic waveforms in a processing chain, to detect similar events, as at 1016 (FIG. 2, 212, determining a processing chain may include using the wave arrivals as determined using the filter).

In an embodiment, identifying at 1006 may include selecting a detection transform, as at 1018 (e.g., FIG. 4, 404, select a detection transform). Further, identifying at 1006 may include applying the detection transform to the one or more synthetic waveforms, as at 1020 (e.g., FIG. 4, apply the selected detection transform to the synthetic waveforms). One or more peaks of the detection transform may be analyzed, such that one or more wave arrivals are identified in the synthetic waveform, as at 1022 (e.g., FIG. 4, 408, analyze the peaks of the selected, applied transform to determine one or more wave arrivals). Further, identifying at 1006 may include determining a catalogue of transforms for calculating an objective function configured to identify wave arrivals in a seismic waveform, as at 1024 (FIG. 4, 410, determine a catalogue of transforms to be used in the continuous calculation of the objective function).

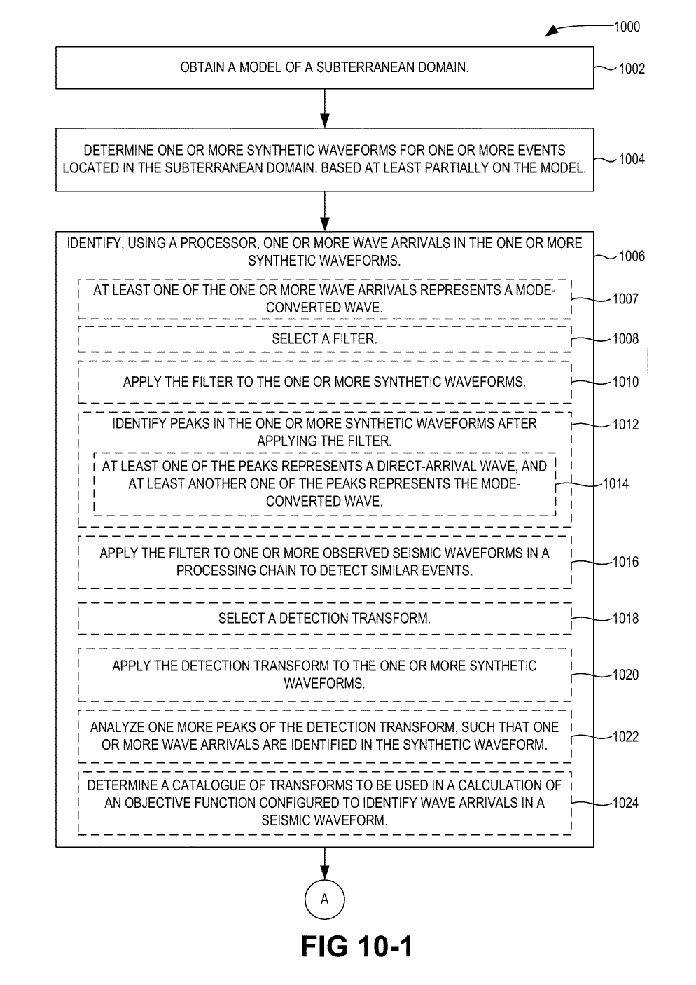

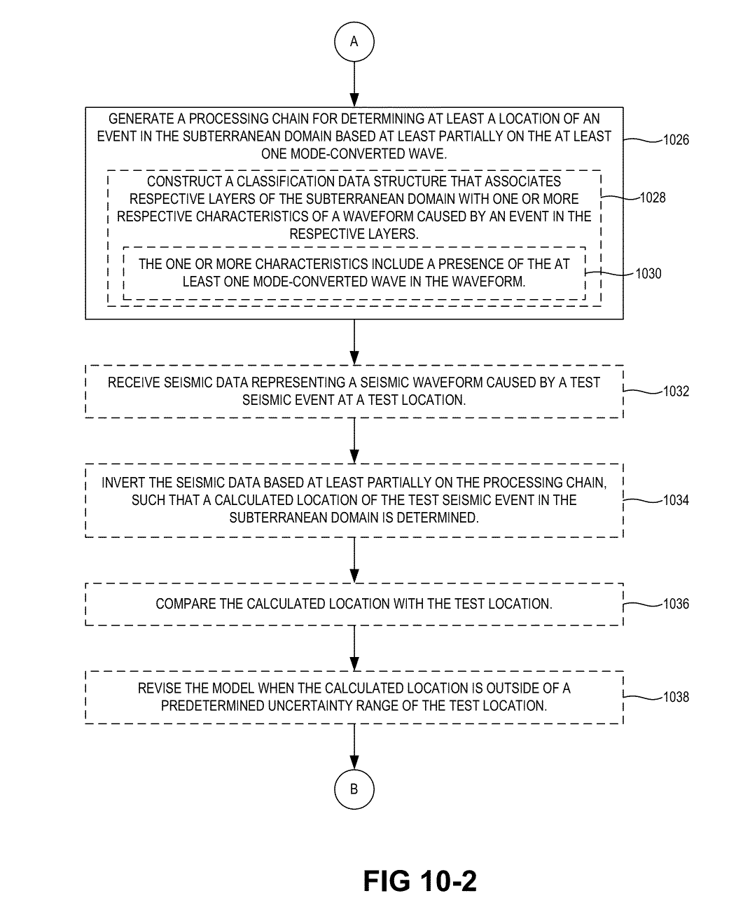

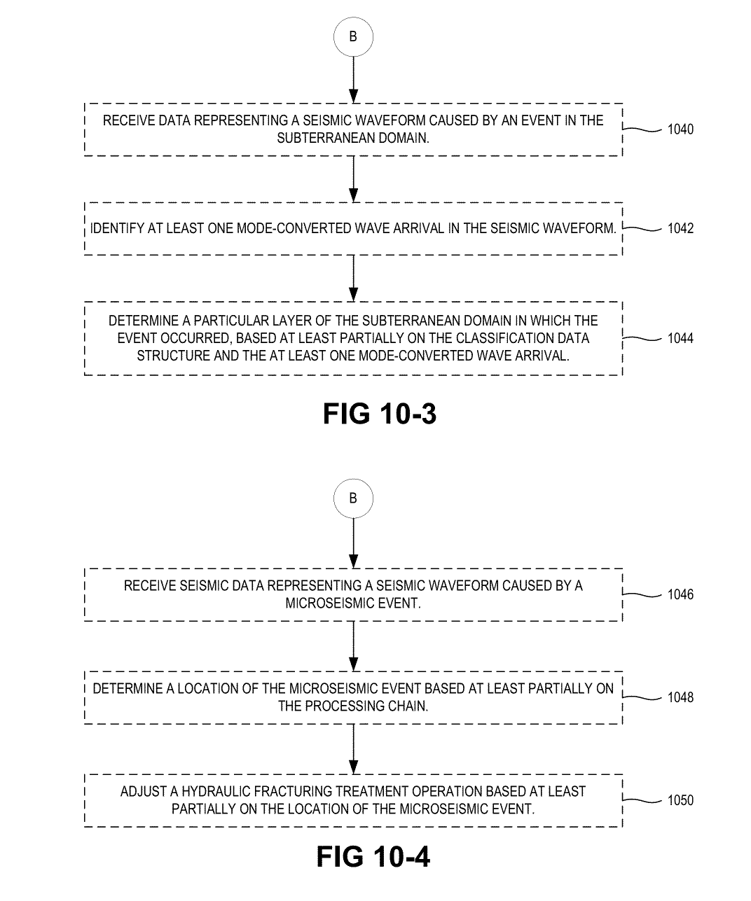

Referring now specifically to FIG. 10-2, the method 1000 may further include generating a processing chain for determining at least a location of an event in the subterranean domain, based at least partially on the at least one mode-converted wave, as at 1026 (e.g., FIG. 2, 212, defining a processing chain). In an embodiment, this may include constructing a classification data structure that associates respective layers of the subterranean domain with one or more respective characteristics of a waveform caused by an event in the respective layers, as at 1028 (e.g., FIG. 6, 606, generating a classification data structure, which may be used in the processing chain, as indicated at 608). Further, in at least one embodiment, the one or more characteristics may include a presence of the at least one mode-converted wave in the waveform, as at 1030 (e.g., FIG. 6, 604, identify one or more arrival characteristics for events occurring at individual rock layers in the subterranean domain; these wave arrivals may include mode-converted waves).

In an embodiment, the method 1000 may also include receiving seismic data representing a seismic waveform caused by a test seismic event at a test location, as at 1032 (e.g., FIG. 2, 216, receive seismic data representing a seismic waveform caused by a test seismic event at a test location). In an embodiment, the method 1000 may further include inverting the seismic data from the test event, based at least partially on the processing chain, such that a calculated location of the test seismic event in the subterranean domain is determined, as at 1034 (e.g., FIG. 2, 218, invert the seismic data based on the processing chain to determine a calculated location). Further, the method 1000 may, in an embodiment, include comparing the calculated location with the test location, as at 1036 (e.g., FIG. 2, 220, determining whether the calculated location matches (within a range of uncertainty) the test location). The method 1000 may also include revising the model when the calculated location is outside of a predetermined uncertainty range of the test location, as at 1038 (e.g., FIG. 2, 222, revising the model).

Referring now to FIG. 10-3, in an embodiment, the method 1000 may include receiving data representing a seismic waveform caused by an event in the subterranean domain, as at 1040 (e.g., FIG. 2, 226, receiving seismic data representing a seismic waveform caused by a microseismic event). The method 1000 may also include identifying at least one mode-converted wave arrival in the seismic waveform, as at 1042 (e.g., FIG. 2, 228, the location is determined using the processing chain, which includes identifying mode-converted waves). The method 1000 may further include determining a particular layer of the subterranean domain in which the event occurred, based at least partially on the classification data structure and the at least one mode-converted wave arrival, as at 1044 (e.g., FIG. 6, 608, the processing chain includes determining a particular layer of the subterranean domain).

Referring now to FIG. 10-4, which illustrates another portion of the method 100 that may proceed in addition to or in lieu of the blocks 1040-1044 of FIG. 10-3, the method 1000 may include receiving seismic data representing a seismic waveform caused by a microseismic event, as at 1046 (e.g., FIG. 2, 226, receiving seismic data representing a seismic waveform caused by a microseismic event). The method 1000 may also include determining a location of the microseismic event, based at least partially on the processing chain, as at 1048 (e.g., FIG. 2, 228, the location is determined using the processing chain). The method 1000 may further include adjusting a hydraulic fracturing treatment operation (e.g., the cause of the microseismic event) based at least partially on the location of the microseismic event, as at 1050.

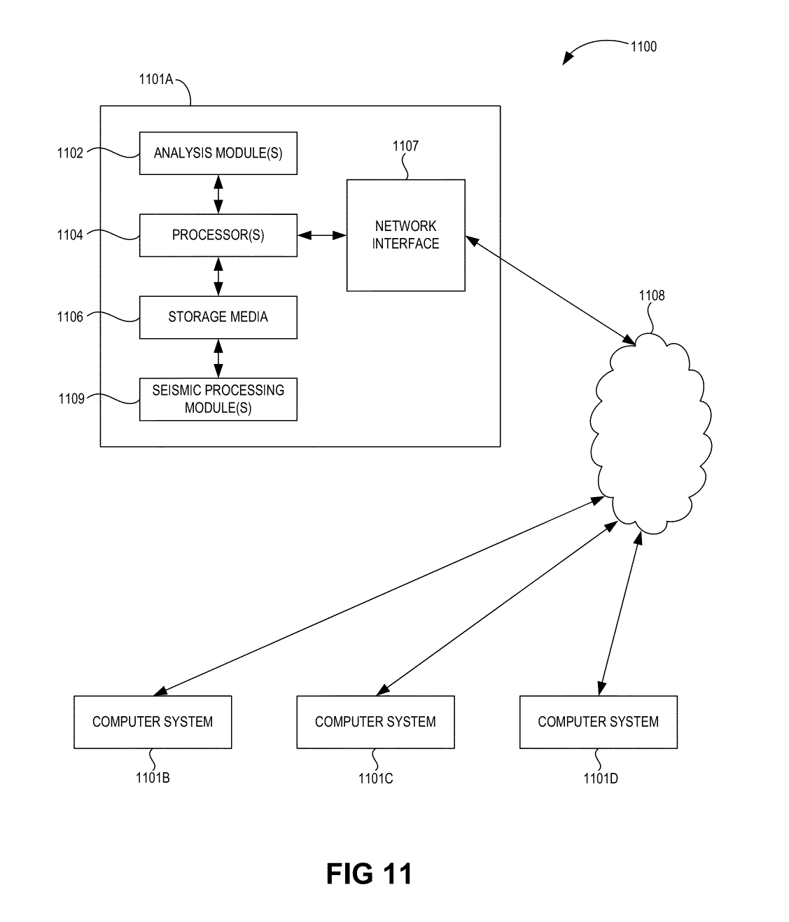

In some embodiments, the methods 100-400, 600 may be executed by a computing system. FIG. 11 illustrates an example of such a computing system 800, in accordance with some embodiments. The computing system 1100 may include a computer or computer system 1101A, which may be an individual computer system 1101A or an arrangement of distributed computer systems. The computer system 1101A includes one or more analysis modules 1102 that are configured to perform various tasks according to some embodiments, such as one or more methods disclosed herein (e.g., methods 100-400, 600, and/or combinations and/or variations thereof). To perform these various tasks, the analysis module 1102 executes independently, or in coordination with, one or more processors 1104, which is (or are) connected to one or more storage media 1106A. The processor(s) 1104 is (or are) also connected to a network interface 1107 to allow the computer system 1101A to communicate over a data network 1108 with one or more additional computer systems and/or computing systems, such as 1101B, 1101C, and/or 1101D (note that computer systems 1101B, 1101C and/or 1101D may or may not share the same architecture as computer system 1101A, and may be located in different physical locations, e.g., computer systems 1101A and 1101B may be located in a processing facility, while in communication with one or more computer systems such as 1101 C and/or 1101D that are located in one or more data centers, and/or located in varying countries on different continents).

A processor can include a microprocessor, microcontroller, processor module or subsystem, programmable integrated circuit, programmable gate array, or another control or computing device.

The storage media 1106A can be implemented as one or more computer-readable or machine-readable storage media. Note that while in the example embodiment of FIG. 11 storage media 1106A is depicted as within computer system 1101A, in some embodiments, storage media 1106A may be distributed within and/or across multiple internal and/or external enclosures of computing system 1101A and/or additional computing systems. Storage media 1106A may include one or more different forms of memory including semiconductor memory devices such as dynamic or static random access memories (DRAMs or SRAMs), erasable and programmable read-only memories (EPROMs), electrically erasable and programmable read-only memories (EEPROMs) and flash memories, magnetic disks such as fixed, floppy and removable disks, other magnetic media including tape, optical media such as compact disks (CDs) or digital video disks (DVDs), BLUERAY® disks, or other types of optical storage, or other types of storage devices. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In some embodiments, computing system 1100 contains one or more seismic processing module(s) 1109. In the example of computing system 1100, computer system 1101A includes the seismic processing module 1109. In some embodiments, a single completion quality determination module may be used to perform some or all aspects of one or more embodiments of the methods 100-400, 600. In alternate embodiments, a plurality of seismic processing modules may be used to perform some or all aspects of methods 100-400, 600.

It should be appreciated that computing system 1100 is only one example of a computing system, and that computing system 1100 may have more or fewer components than shown, may combine additional components not depicted in the example embodiment of FIG. 11, and/or computing system 1100 may have a different configuration or arrangement of the components depicted in FIG. 11. The various components shown in FIG. 11 may be implemented in hardware, software, or a combination of both hardware and software, including one or more signal processing and/or application specific integrated circuits.

Further, the steps in the processing methods described herein may be implemented by running one or more functional modules in information processing apparatus such as general purpose processors or application specific chips, such as ASICs, FPGAs, PLDs, or other appropriate devices. These modules, combinations of these modules, and/or their combination with general hardware are all included within the scope of protection of the invention.

It is important to recognize that geologic interpretations, models and/or other interpretation aids may be refined in an iterative fashion; this concept is applicable to methods 100-400, 600 as discussed herein. This can include use of feedback loops executed on an algorithmic basis, such as at a computing device (e.g., computing system 1100, FIG. 11), and/or through manual control by a user who may make determinations regarding whether a given step, action, template, model, or set of curves has become sufficiently accurate for the evaluation of the subsurface three-dimensional geologic formation under consideration.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. Moreover, the order in which the elements of the methods 100-400, 600 are illustrated and described may be re-arranged, and/or two or more elements may occur simultaneously. The embodiments were chosen and described in order to best explain the principals of the invention and its practical applications, to thereby enable others skilled in the art to best utilize the invention and various embodiments with various modifications as are suited to the particular use contemplated.

What is claimed is:

1. A method for processing seismic data, comprising:
obtaining a model of a subterranean domain;
determining one or more synthetic waveforms for one or more events located in the subterranean domain, based at least partially on the model;
identifying, using a processor, one or more wave arrivals in the one or more synthetic waveforms, wherein at least one of the one or more wave arrivals represents a mode-converted wave; and
generating a processing chain for determining at least a location of an event in the subterranean domain based at least partially on the at least one mode-converted wave.

2. The method of claim 1, further comprising constructing a classification data structure that associates respective layers of the subterranean domain with one or more respective characteristics of a waveform caused by an event in the respective layers, wherein the one or more characteristics include a presence of the at least one mode-converted wave in the waveform.

3. The method of claim 2, further comprising:
receiving data representing a seismic waveform caused by an event in the subterranean domain;
identifying at least one mode-converted wave in the seismic waveform; and
determining a particular layer of the subterranean domain in which the event occurred, based at least partially on the classification data structure and the at least one mode-converted wave arrival.

4. The method of claim 1, wherein identifying the one or more wave arrivals comprises:
selecting a filter;
applying the filter to the one or more synthetic waveforms; and
identifying peaks in the one or more synthetic waveforms after applying the filter, wherein at least one of the peaks represents a direct-arrival wave, and at least another one of the peaks represents the mode-converted wave; and
applying the filter to one or more observed seismic waveforms in a processing chain to detect similar events.

5. The method of claim 1, wherein identifying the one or more wave arrivals comprises:
selecting a detection transform;
applying the detection transform to the one or more synthetic waveforms;
analyzing one more peaks of the detection transform, such that one or more wave arrivals are identified in the synthetic waveform; and
determining a catalogue of transforms for calculating an objective function configured to identify one or more wave arrivals in a seismic waveform.

6. The method of claim 1, further comprising:
receiving seismic data representing a seismic waveform caused by a test seismic event at a test location;
inverting the seismic data based at least partially on the processing chain, such that a calculated location of the test seismic event in the subterranean domain is determined;
comparing the calculated location with the test location; and
revising the model when the calculated location is outside of a predetermined uncertainty range of the test location.

7. The method of claim 1, further comprising:
receiving seismic data representing a seismic waveform caused by a microseismic event; and
determining a location of the microseismic event based at least partially on the processing chain.

8. The method of claim 7, further comprising adjusting a hydraulic fracturing treatment operation based at least partially on the location of the microseismic event.

9. A non-transitory, computer-readable medium storing instructions that, when executed by one or more processors of a computing system, cause the computing system to perform operations, the operations comprising:
obtaining a model of a subterranean domain;
determining one or more synthetic waveforms for one or more events located in the subterranean domain, based at least partially on the model;
identifying one or more wave arrivals in the one or more synthetic waveforms, wherein at least one of the one or more arrivals represents a mode-converted wave; and
generating a processing chain for determining at least a location of an event in the subterranean domain based at least partially on the at least one mode-converted wave.

10. The medium of claim 9, wherein the operations further comprise constructing a classification data structure that associates respective layers of the subterranean domain with one or more respective characteristics of a waveform caused by an event in the respective layers, wherein the one or more characteristics include a presence of the at least one mode-converted wave in the waveform.

11. The medium of claim 10, wherein the operations further comprise:
receiving data representing a seismic waveform caused by an event in the subterranean domain;
identifying at least one mode-converted wave arrival in the seismic waveform; and
determining a particular layer of the subterranean domain in which the event occurred, based at least partially on the classification data structure and the at least one mode-converted wave arrival.

12. The medium of claim 9, wherein identifying the one or more wave arrivals comprises:
selecting a filter;
applying the filter to the one or more synthetic waveforms; and
identifying peaks in the one or more synthetic waveforms after applying the filter, wherein at least one of the peaks represents a direct-arrival wave, and at least another one of the peaks represents the mode-converted wave; and
applying the filter to one or more observed seismic waveforms in a processing chain to detect similar events.

13. The medium of claim 9, wherein identifying the one or more wave arrivals comprises:
selecting a detection transform;
applying the detection transform to the one or more synthetic waveforms;
analyzing one more peaks of the detection transform, such that one or more wave arrivals are identified in the synthetic waveform; and
determining a catalogue of transforms for calculating an objective function configured to identify one or more wave arrivals in a seismic waveform.

14. The medium of claim 9, further comprising:
receiving seismic data representing a seismic waveform caused by a test seismic event at a test location;
inverting the seismic data based at least partially on the processing chain, such that a calculated location of the test seismic event in the subterranean domain is determined;
comparing the calculated location with the test location; and
revising the model when the calculated location is outside of a predetermined uncertainty range of the test location.

15. The medium of claim 9, wherein the operations further comprise:
receiving seismic data representing a seismic waveform caused by a microseismic event; and
determining a location of the microseismic event based at least partially on the processing chain.

16. The medium of claim 15, further comprising adjusting a hydraulic fracturing treatment operation based at least partially on the location of the microseismic event.

17. A computing system, comprising:
one or more processors; and
a memory system comprising one or more non-transitory, computer-readable media storing instructions that, when executed by at least one of the one or more processors, cause the computing system to perform operations, the operations comprising:
obtaining a model of a subterranean domain;
determining one or more synthetic waveforms for one or more events located in the subterranean domain, based at least partially on the model;
identifying one or more arrival waves in the one or more synthetic waveforms, wherein at least one of the one or more wave arrivals represents a mode-converted wave; and
generating a processing chain for determining at least a location of an event in the subterranean domain based at least partially on the at least one mode-converted wave.

18. The system of claim 17, wherein the operations further comprise constructing a classification data structure that associates respective layers of the subterranean domain with one or more respective characteristics of a waveform caused by an event in the respective layers, wherein the one or more characteristics include a presence of the at least one mode-converted wave in the waveform.

19. The system of claim 17. wherein the operations further comprise:
receiving data representing a seismic waveform caused by an event in the subterranean domain;
identifying at least one mode-converted wave arrival in the seismic waveform; and
determining a particular layer of the subterranean domain in which the event occurred, based at least partially on the classification data structure and the at least one mode-converted wave arrival.

20. The system of claim 17, wherein identifying the one or more wave arrivals comprises:
selecting a detection transform;
applying the detection transform to the one or more synthetic waveforms;
analyzing one more peaks of the detection transform, such that one or more wave arrivals are identified in the synthetic waveform; and
determining a catalogue of transforms for calculating an objective function configured to identify one or more wave arrivals in a seismic waveform.
